(19) United States
(12) Patent Application Publication
(10) Pub. No.: US 2026/0074186 A1
(43) Pub. Date: Mar. 12, 2026

(54) POSITIVE ELECTRDODES FOR RECHARGEABLE LITHIUM BATTERIES, METHODS OF MANUFACTURING SAME, AND RECHARGEABLE LITHIUM BATTERIES INCLUDING SAME

(71) Applicant: SAMSUNG SDI CO., LTD., Yongin-si (KR)

(72) Inventor: Dannbee KIM, Yongin-si (KR)

(21) Appl. No.: 19/320,051

(22) Filed: Sep. 5, 2025

(30) Foreign Application Priority Data
Sep. 9, 2024 (KR) 10-2024-0122630

(51) Int. Cl. H01M 4/131; H01M 4/02; H01M 4/04; H01M 4/1391; H01M 4/62; H01M 10/052

(52) U.S. Cl. CPC H01M 4/131; H01M 4/0404; H01M 4/1391; H01M 4/623; H01M 10/052; H01M 2004/021; H01M 2004/028

(57) ABSTRACT

A positive electrode for a rechargeable lithium battery includes: a current collector; a first positive electrode active material layer on a first surface of the current collector; and a second positive electrode active material layer on a second surface of the current collector, wherein the first positive electrode active material layer includes a 1a layer in contact with the current collector and a 1b layer on a surface of the 1a layer, the 1a layer and the 1b layer each include a positive electrode active material and a binder, the 1a layer and the 1b layer have pores, a ratio of a porosity of the 1b layer to a porosity of the 1a layer is about 0.9 to about 1.1, and a thickness ratio of the first positive electrode active material layer to the second positive electrode active material layer is about 1.3:1 to about 3:1.

### CROSS-REFERENCE TO RELATED APPLICATION

The present application claims priority to and the benefit of Korean Patent Application No. 10-2024-0122630, filed on Sep. 9, 2024, in the Korean Intellectual Property Office, the entire content of which is incorporated herein by reference.

### BACKGROUND

### 1. Field

One or more embodiments of the present disclosure relate to positive electrodes for rechargeable lithium batteries, methods of manufacturing the same and rechargeable lithium batteries including the same.

### 2. Description of the Related Art

Rechargeable batteries used in electric vehicles are desired or required to have high capacity characteristics and rapid charging performance to enable long driving distances on a single charge.

For example, rechargeable lithium batteries are mainly used as such batteries. Recently, methods of forming an active material layer on both (e.g., simultaneously) surfaces (e.g., two opposite surfaces) of a current collector with different thicknesses are being studied and/or pursued as a way (means) of satisfying both (e.g., simultaneously) high capacity and rapid charging performance.

### SUMMARY

One or more aspects of embodiments of the present disclosure are directed toward a positive electrode for a rechargeable lithium battery capable of providing such a battery with excellent or suitable high capacity and high output (rapid charging) performance.

One or more aspects of embodiments of the present disclosure are directed toward a rechargeable lithium battery including the positive electrode.

Additional aspects will be set forth in part in the description which follows and, in part, will be apparent from the description, or may be learned by practice of the presented embodiments.

According to one or more embodiments of the present disclosure, a positive electrode for a rechargeable lithium battery includes: a current collector; a first positive electrode active material layer on a first surface of the current collector; and a second positive electrode active material layer on a second surface of the current collector, wherein the first positive electrode active material layer includes a 1a layer (e.g., a first layer) in contact with the current collector and a 1b layer (e.g., a second layer) on a (e.g., one) surface of the 1a layer, the 1a layer and the 1b layer each include a positive electrode active material and a binder, the 1a layer and the 1b layer each have pores, a ratio of a porosity of the 1b layer to a porosity of the 1a layer is about 0.9 to about 1.1, and a thickness ratio of the first positive electrode active material layer and the second positive electrode active material layer is about 1.3:1 to about 3:1.

According to one or more embodiments of the present disclosure, a rechargeable lithium battery includes the positive electrode; a negative electrode; and a non-aqueous electrolyte.

The positive electrode for a rechargeable lithium battery according to one or more embodiments of the present disclosure may provide a rechargeable lithium battery having excellent or suitable high capacity and rapid charging characteristics. For example, the positive electrode may provide a rechargeable lithium battery with high capacity and rapid charging characteristics.

### BRIEF DESCRIPTION OF DRAWINGS

The accompanying drawings are included to provide a further understanding of the present disclosure and are incorporated in and constitute a part of the present disclosure. The drawings illustrate embodiments of the present disclosure and, together with the description, serve to explain principles of the present disclosure. The above and other aspects, features, and advantages of certain embodiments of the present disclosure will be more apparent from the following description taken in conjunction with the accompanying drawings.

FIG. 1 is a cross-sectional view schematically illustrating a positive electrode for a rechargeable lithium battery according to one or more embodiments of the present disclosure.

FIGS. 2-5 are each a schematic diagram showing a rechargeable lithium battery according to one or more embodiments of the present disclosure.

FIG. 6 is a graph showing the charge rates of half cells manufactured according to Examples 1 to 4 and Comparative Examples 1 to 5 of the present disclosure.

FIG. 7 is a graph showing the cycle-life characteristics of Examples 1 and 2 and Comparative Examples 1 and 2 of the present disclosure.

### DETAILED DESCRIPTION

Hereinafter, one or more embodiments of the present disclosure will be described in more detail. However, these embodiments are example, the present disclosure is not limited thereto, and the present disclosure is defined by the scope of appended claims and equivalents thereof.

As used herein, if (e.g., when) specific definition is not otherwise provided, it will be understood that if (e.g., when) an element such as a layer, film, region, or substrate is referred to as being “on” another element, the element may be directly on the other element, or intervening elements may be present therebetween. In contrast, if (e.g., when) an element is referred to as being “directly on” another element, there are no intervening elements present.

As used herein, if (e.g., when) specific definition is not otherwise provided, the singular may also include the plural, for example, the singular forms “a,” “an,” and “the” are intended to include the plural forms as well, unless the context clearly indicates otherwise. Unless otherwise specified, “A and/or B,” or “A or B” may refer to “including A, including B, or including A and B.” Further, the utilization of “may” when describing embodiments of the present disclosure refers to “one or more embodiments of the present disclosure.”

As used herein, “combination thereof” may refer to a mixture, a stack, a composite, a copolymer, an alloy, a blend, or a reaction product of constituents.

As used herein, if (e.g., when) a definition is not otherwise provided, a particle diameter may be an average particle diameter. This average particle diameter refers to an average particle diameter (D50), which is a diameter of particles with a cumulative volume of 50 volume % in a particle size distribution. The particle diameter (D50) may be measured by methods well suitable to those skilled in the art, for example, by measuring with a particle size analyzer, a transmission electron microscope (TEM), or a scanning electron microscope (SEM). In one or more embodiments, a dynamic light-scattering measurement device may be used to perform a data analysis, and the number of particles is counted for each particle size range. From the collected data, the average particle diameter (D50) value may be easily obtained through a calculation. In one or more embodiments, a laser diffraction method may be used. If measuring by laser diffraction, the particles to be measured may be dispersed in a dispersion medium and then introduced into a commercially available laser diffraction particle size measuring device (e.g., MT 3000 available from Microtrac, Inc.) using ultrasonic waves at about 28 kHz, and after irradiation with an output of 60 W, the average particle diameter (D50) based on 50 volume % of the particle size distribution in the measuring device may be calculated. In the present disclosure, D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size. In the present disclosure, when particles are spherical, “diameter” indicates a particle diameter or an average particle diameter, and when the particles are non-spherical, the “diameter” indicates a major axis length or an average major axis length.

In one or more embodiments, the average particle size may be measured by one or more suitable methods described above, for example, through a particle size analyzer.

In one or more embodiments, the thickness of an element (e.g., a layer, a film, and/or the like) may be measured using an SEM or TEM image of a cross-section thereof, but embodiments of the present disclosure are not limited thereto, and the thickness may be measured using any method that may measure thickness in the relevant field. In one or more embodiments, the thickness may be an average thickness.

As used herein, soft carbon refers to a graphitizable carbon material that may be graphitized by heat treatment at high temperatures, for example at about 2800° C., and hard carbon refers to non-graphitizable carbon material that is not graphitized by heat treatment. The soft carbon and hard carbon are well available and suitable in the art.

In one or more embodiments, crystalline carbon and amorphous carbon may be classified by X-ray diffraction analysis. The crystalline carbon includes natural graphite and/or artificial graphite. The natural graphite refers to naturally occurring graphite obtained by separation from minerals, and having, upon X-ray diffraction analysis, d002 of about 3.350 angstroms (Å) to about 3.360 Å. The artificial graphite refers to graphite made by graphitization and having, upon X-ray diffraction analysis, d002 of about 3.355 Å to about 3.365 Å. The amorphous carbon has a d002 of less than or equal to about 3.34 Å when analyzed by X-ray diffraction. The X-ray diffraction analysis (XRD) uses CuKα ray as a target line and uses an X-ray diffraction analyzer, for example, X′Pert (manufacturer: Malvern Panalytical). To improve peak intensity resolution, the monochromator equipment may be removed and the spectra are measured. The measurement conditions may be 2θ=10° to 80°, scan rate (°/S)=0.044 to 0.089, and step size (°/step)=0.013 to 0.039.

In one or more embodiments, the weight average molecular weight of a polymer and/or the like may be measured by gel permeation chromatography.

In one or more embodiments, the porosity of an example (e.g., a layer, a film, a material, and/or the like) may be measured by a mercury porosity analysis method using a mercury intrusion method.

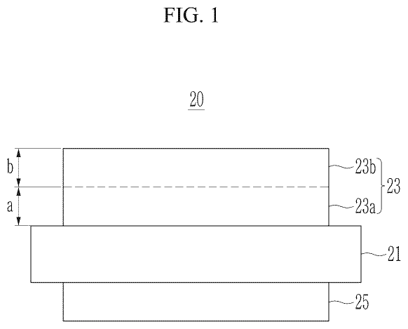

A positive electrode for a rechargeable lithium battery according to one or more embodiments of the present disclosure includes a current collector, a first positive electrode active material layer on a first surface of the current collector, and a second positive electrode active material layer on a second surface of the current collector. FIG. 1 schematically illustrates such a positive electrode, wherein the positive electrode 20 includes a current collector 21, a first positive electrode active material layer 23 on a first surface of the current collector 21, and a second positive electrode active material layer 25 on a second surface of the current collector 21. The first surface and the second surface are opposite to each other, as shown in FIG. 1.

In one or more embodiments, the first positive electrode active material layer may include a 1a layer (e.g., a first layer) in contact with the current collector and a 1b layer (e.g., a second layer) on a (e.g., one) surface of the 1a layer or on (e.g., directly on) the 1a layer. The first positive electrode active material layer may correspond to a double layer structure. For example, as shown in FIG. 1, in one or more embodiments, the first positive electrode active material layer 23 includes a 1a layer 23a (corresponding to a lower layer) in contact with the current collector 21 and a 1b layer 23b (corresponding to an upper layer) on a (e.g., one) surface of the 1a layer 23a.

In one or more embodiments, the second positive electrode active material layer may be a single layer (e.g., exactly one layer).

In one or more embodiments, a thickness of the first positive electrode active material layer is thicker than a thickness of the second positive electrode active material layer, and a thickness ratio of the first positive electrode active material layer to the second positive electrode active material layer may be about 1.3:1 to about 3:1, and about 1.35:1 to about 3:1, about 1.5:1 to about 2.5:1, or about 1.65:1 to about 2.2:1.

In this way, the positive electrode according to one or more embodiments includes two active material layers formed on opposite sides of a current collector, respectively a thick layer and a thin layer, wherein the thick layer is a double layer and the thin layer is a single layer, and the thicknesses of the thick layer and the thin layer satisfy the thickness ratio described herein.

By forming the first positive electrode active material layer, which is a thick layer, into a double layer, the layer thickness may be formed large without increasing resistance, so that a high capacity may be obtained. Because the thickness ratio of the first positive electrode active material layer and the second positive electrode active material layer satisfies the above described ranges, a sufficiently high capacity may be obtained from the first positive electrode active material layer, and because the thin layer has low resistance, it may be formed as a single layer, so the manufacturing process may be simplified.

In one or more embodiments, if (e.g., when) the first positive electrode active material layer having a double layer structure is thicker than the second positive electrode active material layer having a single layer structure, and if (e.g., when) the thickness ratio of the first positive electrode active material layer to the second positive electrode active material layer is within the above described ranges, the effects of rapid charging and high capacity may be obtained. If (e.g., when) the thickness ratio of the first positive electrode active material layer to the second positive electrode active material layer is outside the above range, a resistance ratio of the thicker layer among the entire active material layers, for example, the first positive electrode active material layer, becomes very large, resulting in an increase in the battery direct current internal resistance (DCIR), an increase in overvoltage, and a decrease in rapid charging performance.

For example, a positive electrode for a rechargeable lithium battery, according to one or more embodiments, includes a current collector with a first positive electrode active material layer on one surface and a second positive electrode active material layer on the opposite surface. The first positive electrode active material layer may have a double-layer structure, while the second positive electrode active material layer is a single layer. The thickness of the first positive electrode active material layer is greater than that of the second positive electrode active material layer, with a thickness ratio ranging from about 1.3:1 to about 3:1. This configuration allows for high capacity and rapid charging performance, as the double-layer structure of the first positive electrode active material layer reduces resistance, and the single-layer structure of the second positive electrode active material layer simplifies the manufacturing process.

By maintaining the specified thickness ratio, the positive electrode achieves both high capacity and rapid charging characteristics. If the ratio falls outside the specified range, the battery's direct current internal resistance (DCIR) increases, leading to higher overvoltage and reduced rapid charging performance. This design ensures that the battery may deliver excellent performance while being efficient to manufacture.

In one or more embodiments, a thickness of the first positive electrode active material layer may be about 65 micrometers (μm) to about 240 μm, about 82 μm to about 188 μm, or about 90 μm to about 154 μm.

A thickness of the second positive electrode active material layer may be about 50 μm to about 80 μm, about 55 μm to about 75 μm, or about 60 μm to about 70 μm.

If (e.g., when) the thickness ratio of the first positive electrode active material layer and the second positive electrode active material layer satisfies the above described ranges, and the thicknesses of the first positive electrode active material layer and the second positive electrode active material layer each satisfies the above described ranges, the positive electrode may be manufactured more easily, the rapid charging characteristics may be further improved without increasing resistance, and at the same time, the capacity increase effect may be obtained.

In one or more embodiments, a thicker layer may have a higher loading level of positive electrode active material than a thinner layer. A loading level refers to the amount of active material per unit area (g/cm²). For example, a ratio of a loading level of the first positive electrode active material layer to a loading level of the second positive electrode active material layer may be about 1.5:1 to about 4:1, about 1.8:1 to about 3:1, or about 2:1 to about 2.5:1.

In one or more embodiments, the 1a layer and the 1b layer may have pores, and for example, a porosity ratio (P1b/P1a) of a porosity (P1b) of the 1b layer to a porosity (P1a) of the 1a layer may be about 0.8 to about 1.3. In one or more embodiments, the porosity ratio (P1b/P1a) may be about 0.9 to about 1.2, or about 0.9 to about 1.1. If (e.g., when) the porosity ratio (P1b/P1a) is within the above ranges, it indicates that the porosities of the 1a layer and the 1b layer are almost similar, which refers to that the porosity distribution within the positive electrode is substantially uniform. If (e.g., when) the porosity distribution within the positive electrode is substantially uniform, the movement of lithium ions within the electrolyte becomes smooth, and the rapid charging resistance (Rᵢₒₙ) may be reduced by improving the tortuosity. For example, the 1a and 1b layers of the positive electrode may have pores, with a porosity ratio (P1b/P1a) ranging from about 0.8 to about 1.3. This ratio indicates that the porosities of the 1a and 1b layers are almost similar (e.g., substantially the same), resulting in a substantially uniform porosity distribution within the positive electrode. A uniform porosity distribution facilitates smooth movement of lithium ions within the electrolyte, reducing rapid charging resistance (Rᵢₒₙ) by improving tortuosity (e.g., lower tortuosity).

In one or more embodiments, the porosity of each layer may be measured by a mercury porosity analysis method using a mercury intrusion method. The mercury porosity analysis is an analytical method that uses the penetration of mercury into a porous structure under controlled or selected pressure.

In one or more embodiments, the porosity of the 1a layer may be about 10% to about 30%, about 15% to about 30%, about 17% to about 25%, or about 20% to about 25%.

The porosity of the 1b layer may be about 10% to about 30%, about 15% to about 30%, about 15% to about 25%, or about 20% to about 25%.

If (e.g., when) the porosity of the 1a layer or the 1b layer satisfies the above ranges, the ionic resistance may be mitigated due to an appropriate or suitable and substantially uniform porosity distribution within the positive electrode, thereby improving the rapid charging cycle-life.

The second positive electrode active material layer may also have pores. A porosity of the second positive electrode active material layer may be about 5% to about 20%. In one or more embodiments, the porosity of the second positive electrode active material layer may be about 10% to about 20%, or about 15% to about 20%. If (e.g., when) the porosity of the second positive electrode active material layer is within the above-described ranges, the movement of ions within the positive electrode becomes smoother, so that the resistance may be further reduced during charge and discharge.

In one or more embodiments, the 1a layer and the 1b layer each include a positive electrode active material and a binder, and a binder amount of the 1a layer and a binder amount of the 1b layer may be substantially the same.

In one or more embodiments, the binder amount refers to a binder amount included in each layer based on 100 wt % of a total weight of the first positive electrode active material layer. In one or more embodiments, the binder amount of the 1a layer and the binder amount of the 1b layer are substantially the same, which refers to that the binder amount of the 1a layer based on 100 wt % of the total weight of the first positive electrode active material layer is almost the same as that of the 1b layer.

For example, in one or more embodiments, a ratio of the binder amount of the 1b layer to that of the 1a layer may be a weight ratio of about 4:6 to about 6:4, for example, about 5:5 to about 4.5:5.5.

In one or more embodiments, the binder amount of the 1a layer may be about 0.5 wt % to about 4 wt %, about 0.5 wt % to about 3 wt %, or about 1 wt % to about 2 wt % based on 100 wt % of the total weight of the first positive electrode active material layer. If (e.g., when) the binder amount of the 1a layer falls within the ranges, non-uniformity of the binder caused by migration during the drying during the positive electrode-manufacturing process may be well resolved, resulting in substantially uniform porosity and significantly reducing resistance.

The binder amount of the 1b layer may be about 0.5 wt % to about 3.5 wt %, about 0.5 wt % to about 3 wt %, or about 0.5 wt % to about 2 wt % based on 100 wt % of the total weight of the first positive electrode active material layer.

If (e.g., when) the 1a layer and the 1b layer have a binder amount ratio within the described ranges, each binder amount of the 1a layer and the 1b layer is within the disclosed ranges, the resistance of the positive electrode may be further reduced, thereby much more improving rapid charging characteristics.

The positive electrode according to one or more embodiments may have a smaller binder amount in the 1b layer, in which binder may act as resistance during the charging and discharging, for example, the rapid charging and discharging (the high rate charging and discharging), than if (e.g., when) formed as a single layer and may achieve high capacity and excellent or suitable rapid charge and discharge by thickly forming the first positive electrode active material layer.

If (e.g., when) the binder amount of the 1b layer to that of the 1a layer has a ratio within the disclosed ranges, a charging rate and high-rate cycle-life characteristics may be much more improved.

In one or more embodiments, the binder amount may be measured by using an SAICAS equipment. For example, each binder amount at the upper/middle/lower positions of the positive electrode active material layer may be obtained by measuring a force (KN/m) applied to a blade, while peeling the positive electrode active material layer at the positions. The measurement using the SAICAS equipment may be carried out as below:
Measurement Unit: KN/m
Measurement Speed: Horizontal 10 μm/s and Vertical 1 μm/s
Measurement Method:
1) The total thickness of a sample is measured and the probe is then
moved vertically downward by 5 μm from the top surface of the electrode.
2) Upon reaching the designated depth, the probe is moved in a horizontal direction for 100 seconds while measuring the force.
3) The probe is then returned to the top surface of the electrode, the zero point is reset, and the probe is moved vertically downward by 10 μm.
4) At this depth, the probe is again moved in the horizontal direction for 100 seconds while measuring the force.
5) Starting from the zero point, the probe is moved downward in 5 μm increments vertically at each increment, and the force is measured during the horizontal movement at each step until the substrate surface is reached.

The higher force, the larger binder amount.

In one or more embodiments, the thickness of the 1a layer (a in FIG. 1) and the thickness of the 1b layer (b of FIG. 1) consisting of the first positive electrode active material layer may have a ratio of about 5:5 to about 3:7 or about 4:6 to about 3:7. If (e.g., when) the 1a layer and the 1b layer have a thickness ratio within the ranges, that is, if (e.g., when) the thickness of the 1a layer is the same as or smaller than that of the 1b layer, there may be advantageous in the rapid charging performance due to a decrease in resistance caused by a decrease in binder weights (%) in the middle and upper portions of the first positive electrode active material layer out of a total binder weight of the first positive electrode active material layer.

The 1a layer may have a thickness of about 22 μm to about 120 μm, about 30 μm to about 100 μm, or about 40 μm to about 80 μm.

The 1b layer may have a thickness of about 37 μm to about 168 μm, about 50 μm to about 140 μm, or about 60 μm to about 120 μm.

In one or more embodiments, the binder amount of the first positive electrode active material layer may be about 1 wt % to about 4 wt % or about 1 wt % to 3 about wt % based on 100 wt % of the total weight of the first positive electrode active material layer. The first positive electrode active material layer has a double layer structure of the 1a layer and the 1b layer, and accordingly, the binder amount of the first positive electrode active material layer may be obtained by measuring the binder amounts of the two layers based on 100 wt % of a total solid amount of the two layers.

The second positive electrode active material layer may have a binder amount of about 1 wt % to about 4 wt % or about 1 wt % to about 3 wt % based on 100 wt % of a total weight of the second positive electrode active material layer.

In this way, the first and second positive electrode active material layers arranged on both (e.g., simultaneously) surfaces (e.g., two opposite surfaces) of the current collector may have the same binder amount.

The first positive electrode active material layer may include a positive electrode active material (e.g., in a form of particles), a binder, and a conductive material, (e.g., electron conductor), and accordingly, the 1a layer and the 1b layer consisting of the first positive electrode active material layer may include the positive electrode active material, the binder, the conductive material.

In one or more embodiments, the positive electrode active material, binder, and conductive material included in the 1a layer and the 1b layer may be each the same. In one or more embodiments, the positive electrode active material, binder, and conductive material in the 1a layer and the 1b layer may be different, while satisfying the condition that the binder amount of the 1a layer is greater than the binder amount of the 1b layer.

The second positive electrode active material layer may include a positive electrode active material (e.g., in a form of particles), a binder, and a conductive material (e.g., electron conductor).

The positive electrode active material, binder, and conductive material included in each of the first positive electrode active material layer and the second positive electrode active material layer may be the same or different.

In one or more embodiments, an amount of the positive electrode active material in the first positive electrode active material layer and the second positive electrode active material layer may be about 91 wt % to about 99 wt % based on 100 wt % of the total weight of the first positive electrode active material layer and 100 wt % of the total weight of the second positive electrode active material layer, respectively, and an amount of the conductive material in the first positive electrode active material layer and the second positive electrode active material layer may be about 0.5 wt % to about 5 wt % based on 100 wt % of the total weight of the first positive electrode active material layer and 100 wt % of the total weight of the second positive electrode active material layer, respectively.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like, but embodiments of the present disclosure are not limited thereto.

The positive electrode active material may be a compound (lithiated intercalation compound) capable of intercalating and deintercalating lithium. In one or more embodiments, one or more types (kinds) of composite oxides of lithium and a metal selected from among cobalt, manganese, nickel, and/or one or more (e.g., any suitable) combinations thereof may be used.

In one or more embodiments, the composite oxide may be a lithium transition metal composite oxide, and non-limiting examples thereof may include a lithium nickel-based oxide, a lithium cobalt-based oxide, a lithium manganese-based oxide, a lithium iron phosphate-based compound, a cobalt-free lithium nickel-manganese-based oxide, and/or a (e.g., any suitable) combination thereof.

In one or more embodiments, a compound represented by any of (e.g., any one selected from among) the following chemical formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L_{d}¹GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A may be nickel (Ni), cobalt (Co), manganese (Mn), or a (e.g., any suitable) combination thereof; X may be Al, Ni, Co, Mn, chromium (Cr), iron (Fe), magnesium (Mg), strontium (Sr), vanadium (V), a rare earth element, or a (e.g., any suitable) combination thereof; D may be oxygen (O), fluorine (F), sulfur(S), phosphorous (P), or a (e.g., any suitable) combination thereof; G may be Al, Cr, Mn, Fe, Mg, lanthanum (La), cerium (Ce), Sr, V, or a (e.g., any suitable) combination thereof; and L¹ may be Mn, Al, or a (e.g., any suitable) combination thereof.

For example, in one or more embodiments, the positive electrode active material may be a high nickel-based positive electrode active material having a nickel amount of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of a total metal excluding lithium in the lithium transition metal composite oxide. The high-nickel-based positive electrode active material may realize high capacity and may be applied to a high-capacity, high-density rechargeable lithium battery.

The conductive material may be used to impart conductivity (e.g., electrical conductivity) to the electrode. Any material that does not cause chemical change (e.g., does not cause an undesirable chemical change in the rechargeable lithium battery) and conducts electrons may be used in the battery. Non-limiting examples of the conductive material may include a carbon-based material such as natural graphite, artificial graphite, carbon black, acetylene black, Ketjen black, a carbon fiber, a carbon nanofiber, and/or carbon nanotube; a metal-based material including copper, nickel, aluminum, silver, and/or the like, in a form of a metal powder or a metal fiber; a conductive polymer such as a polyphenylene derivative; and/or a (e.g., any suitable) mixture thereof.

In one or more embodiments, the current collector may include Al, but embodiments of the present disclosure are not limited thereto.

### Method of Manufacturing Positive Electrode

A positive electrode according to one or more embodiments of the present disclosure may be manufactured by the following process.

A 1a layer composition including a positive electrode active material, a binder, a conductive agent, and a solvent may be coated on a (e.g., one) surface of a current collector to manufacture a 1a layer. After the coating process, drying, and compressing processes are performed.

Subsequently, a 1b layer composition including a positive electrode active material, a binder, a conductive material, and a solvent may be coated on the 1a layer to produce a 1b layer, thereby manufacturing a first positive electrode active material layer including the 1a layer and the 1b layer.
The 1a layer composition and the 1b layer composition are respectively prepared by mixing the positive electrode active material, the binder, and the conductive material in the solvent.

The positive electrode active material, the binder, the conductive material, and the solvent in the 1a layer composition and the 1b layer composition may be respectively the same or different each other.

An amount of the binder included in the 1a layer composition may be larger than that of the binder included in the 1b layer composition. In one or more embodiments, that the binder amount of the 1a layer composition is larger refers to that the binder amount of the 1a layer composition is larger than that of the 1b layer composition based on 100 wt % of a total binder amount of the 1a layer composition and the 1b layer composition.

For example, in one or more embodiments, the binder amount of the 1b layer composition and the binder amount included in the 1a layer composition may have a weight ratio of about 1:9 to about 4:6 or about 3:7 to about 4:6. If (e.g., when) the 1a layer and the 1b layer are formed by setting the binder amount of the 1a layer composition to be larger than that of the 1b layer composition, the binder may move toward the upper layer (1b layer) by binder migration naturally occurring during its subsequent drying process, and as a result, the 1a layer and the 1b layer may have substantially almost the same binder amount. For example, in the manufactured positive electrode, the binder included in the 1a layer and the binder included in the 1b layer may have a weight ratio of about 5:5 to about 6:4.

The binder amount of the 1a layer composition may be about 60 wt % to about 90 wt %, about 70 wt % to about 90 wt %, or about 80 wt % to about 90 wt % based on 100 wt % of a total binder amount of the 1a layer composition and the 1b layer composition. If (e.g., when) the 1a layer composition has a binder amount within these ranges, the non-uniformity of the binder caused by the migration during the positive electrode manufacturing process may be well resolved, providing more substantially uniform porosity and significantly reducing resistance.

The binder amount of the 1b layer composition may be about 10 wt % to about 40 wt %, about 15 wt % to about 35 wt %, or about 20 wt % to about 30 wt % based on 100 wt % of a total binder amount of the 1a layer composition and the 1b layer composition.

The 1a layer composition and the 1b layer composition may be appropriately or suitably adjusted to include the positive electrode active material and the conductive material in substantially the same amounts as included in the 1a layer and the 1b layer in the manufactured positive electrode.

If (e.g., when) the binder amount of the 1a layer (lower layer) composition is larger than that of the 1b layer (upper layer) composition, because adhesive strength to the current collector may be much increased, even though the first positive electrode active material layer is thickly formed, the active material layer may not be detached during the repetitive charging and discharging, effectively accomplishing high capacity according to formation of the first positive electrode active material layer to be thick. If (e.g., when) the 1a layer composition has the same the binder amount as or lower than that of the 1b layer composition, because adhesive strength to the current collector may be deteriorated, the first positive electrode active material layer may be detached during the manufacturing process, or as the 1a layer and the 1b layer have different porosity in the manufactured positive electrode, cycle-life characteristics may be deteriorated, and rapid charging and discharging characteristics also may be deteriorated due to an increase in resistance.

In each of the 1a layer composition and the 1b layer composition, the solvent may be an organic solvent, for example, N-methyl pyrrolidone, but embodiments of the present disclosure are not limited thereto.

After coating the 1b layer composition, drying and compressing processes are performed.

The drying and compressing processes may be performed so that the 1a layer and the 1b layer may have a thickness ratio of about 5:5 to about 3:7 or about 4:6 to about 3:7, for example, under the conditions of a general electrode manufacturing process but are not particularly limited.

Subsequently, on the other surface of the current collector having the first positive electrode active material layer on one surface, a second positive electrode active material layer composition including a positive electrode active material, a binder, and a solvent may be coated to form a second positive electrode active material layer. After the coating process, drying and compressing processes are performed. The drying and compressing processes may be performed under the conditions of the general electrode manufacturing process but are not particularly limited.

### <Rechargeable Lithium Battery>

According to one or more embodiments of the present disclosure, a rechargeable lithium battery may include the positive electrode, a negative electrode, and a non-aqueous electrolyte.

### Negative Electrode

The negative electrode for a rechargeable lithium battery may include a negative electrode current collector and a negative electrode active material layer on the negative electrode current collector. The negative electrode active material layer may include a negative electrode active material (e.g., in a form of particles) and may further include a binder and/or a conductive material.

For example, the negative electrode active material layer may include about 90 wt % to about 99 wt % of the negative electrode active material and about 1 wt % to about 5 wt % of the binder, based on 100 wt % of a total weight of the negative electrode active material layer. If (e.g., when) the negative electrode active material layer further includes a conductive material, the negative electrode active material may be included in an amount of about 90 wt % to about 99 wt %, the binder in an amount of about 0.5 wt % to about 5 wt %, and the conductive material in an amount of about 0.5 wt % to about 5 wt %, based on 100 wt % of the total weight of the negative electrode active material layer.

The negative electrode active material may include a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may include a carbon-based negative electrode active material, for example, crystalline carbon, amorphous carbon and/or a (e.g., any suitable) combination thereof. The crystalline carbon may be graphite such as unspecific shaped, sheet-shaped, flake-shaped, sphere-shaped, or fiber-shaped natural graphite and/or artificial graphite, and the amorphous carbon may be a soft carbon, a hard carbon, a mesophase pitch carbonization product, calcined coke, and/or the like.

The lithium metal alloy may include an alloy of lithium and a metal selected from among sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn).

The material capable of doping/dedoping lithium may be a Si-based negative electrode active material or a Sn-based negative electrode active material. The Si-based negative electrode active material may include silicon, a silicon-carbon composite, SiOₓ (0<x≤2), a Si-Q alloy (wherein Q is selected from among an alkali metal, an alkaline-earth metal, a Group 13 element, a Group 14 element (excluding Si), a Group 15 element, a Group 16 element, a transition metal, a rare earth element, and/or a (e.g., any suitable) combination thereof). The Sn-based negative electrode active material may include Sn, SnOₓ (0<x≤2) (e.g., SnO₂), a Sn-based alloy, and/or a (e.g., any suitable) combination thereof.

The silicon-carbon composite may be a composite of silicon and carbon, in a form of particles. The carbon may include amorphous carbon, or amorphous carbon and crystalline carbon. The crystalline carbon may be natural graphite, artificial graphite, or a (e.g., any suitable) combination thereof, in the form of unspecific-shaped, plate-shaped, flake-shaped, spherical, or fibrous graphite. The amorphous carbon may be soft carbon, hard carbon, a mesophase pitch carbonized product, calcined coke, or a (e.g., any suitable) combination thereof.

In one or more embodiments, the silicon-carbon composite may be in a form of silicon particles and amorphous carbon coated on the surface of each of the silicon particles. For example, in one or more embodiments, the silicon-carbon composite may include silicon particles and an amorphous carbon coating layer on the surface of each of the silicon particles. In one or more embodiments, it may include a secondary particle (core) where silicon primary particles are agglomerated and an amorphous carbon coating layer (shell) on the surface of the secondary particle. The amorphous carbon may also be positioned between the silicon primary particles, so that, for example, the silicon primary particles may be coated with the amorphous carbon. For example, the secondary particles may be present to be dispersed in an amorphous carbon matrix. The silicon primary particles may be nano silicon particles. An average particle diameter of the nano silicon particles may be about 10 nanometers (nm) to about 900 nm, about 10 nm to about 800 nm, about 10 nm to about 500 nm, about 10 nm to about 300 nm, or about 10 nm to about 200 nm. If (e.g., when) the average particle diameter of the nano silicon particles is within the above ranges, excessive volume expansion that occurs during charging and discharging may be suppressed or reduced, and disconnection of the conductive path due to particle crushing during charging and discharging may be prevented or reduced. In one or more embodiments, the particle size of the silicon secondary particles need not be particularly limited.

A thickness of the amorphous carbon coating layer may be appropriately or suitably controlled or selected, but may be, for example, about 2 nm to about 800 nm, about 5 nm to about 600 nm, about 10 nm to about 400 nm, or about 20 nm to about 200 nm. The thickness of the amorphous carbon coating layer may be measured by SEM or TEM images of a cross-section of the silicon-carbon composite (e.g., silicon-carbon composite particle), but embodiments of the present disclosure are not limited thereto, and any method capable of measuring the thickness of the amorphous carbon coating layer in the related field may be used.

The average particle size of the silicon-carbon composite may be suitably controlled or selected, for example, may be less than or equal to about 30 μm, for example, about 1 μm to about 30 μm, about 2 μm to about 25 μm, about 3 μm to about 20 μm, or about 5 μm to about 15 μm.

Based on 100 wt % of a total weight of the silicon-carbon composite, an amount of the silicon particles may be about 30 wt % to about 70 wt %, or about 40 wt % to about 65 wt %. An amount of the amorphous carbon may be about 30 wt % to about 70 wt %, or about 35 wt % to about 60 wt %, based on 100 wt % of the total weight of the silicon-carbon composite. If (e.g., when) the amount of silicon particles and amorphous carbon satisfies the above ranges, higher capacity may be achieved.

In one or more embodiments, the silicon-carbon composite may include a core including silicon particles and crystalline carbon and an amorphous carbon coating layer on a surface of the core. For example, in one or more embodiments, the silicon-carbon composite may include a core including secondary particles where silicon primary particles and crystalline carbon are agglomerated, and an amorphous carbon coating layer on the core. The amorphous carbon may be located between silicon primary particles or between crystalline carbon, so that amorphous carbon may be also filled between silicon primary particles and/or crystalline carbon.

If (e.g., when) the silicon-carbon composite includes silicon particles, crystalline carbon, and amorphous carbon, an amount of the crystalline carbon may be about 10 wt % to about 70 wt % or about 20 wt % to about 60 wt %, based on 100 wt % of a total weight of the silicon particles, the amorphous carbon, and the crystalline carbon. An amount of the amorphous carbon may be about 20 wt % to about 40 wt % or about 20 wt % to about 30 wt %, and an amount of the silicon particles may be about 10 wt % to about 70 wt % or about 10 wt % to about 60 wt %, based on 100 wt % of the total weight of the silicon particles, the amorphous carbon, and the crystalline carbon.

In one or more embodiments, the negative electrode may further include a carbon-based negative electrode active material together with a silicon-based negative electrode active material as the negative electrode active material. If (e.g., when) the silicon-based negative electrode active material and the carbon-based negative electrode active material are used together, a mixing ratio of the silicon-based negative electrode active material to the carbon-based negative electrode active material may be a weight ratio of about 1:99 to about 50:50. In one or more embodiments, the mixing ratio of the silicon-based negative electrode active material to the carbon-based negative electrode active material may be a weight ratio of about 5:95 to about 20:80.

The binder serves to adhere the negative electrode active material particles to each other and also helps the negative electrode active material to adhere to the negative electrode current collector. The binder may be a non-aqueous (e.g., water-insoluble) binder, an aqueous (e.g., water-soluble) binder, or a (e.g., any suitable) combination thereof.

The non-aqueous binder may be polyvinylchloride, carboxylated polyvinylchloride, polyvinylfluoride, an ethylene propylene copolymer, polystyrene, polyurethane, polytetrafluoroethylene, polyvinylidene fluoride, polyethylene, polypropylene, polyamideimide, polyimide, or a (e.g., any suitable) combination thereof.

The aqueous binder may be a styrene-butadiene rubber, a (meth)acrylated styrene-butadiene rubber, a (meth)acrylonitrile-butadiene rubber, a (meth)acrylic rubber, a butyl rubber, a fluorine rubber, polyethyleneoxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a (e.g., any suitable) combination thereof.

If (e.g., when) using an aqueous binder as the aforementioned negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. The alkali metal may be Na, K, or Li.

The conductive material may be used to impart conductivity to the electrode, and any electrically conductive material may be used as a conductive material unless it causes a chemical change in a battery. Non-limiting examples of the conductive material may include a carbon-based material such as natural graphite, artificial graphite, carbon black, acetylene black, Ketjen black, carbon fiber, carbon nanofibers, carbon nanotubes, and/or the like; a metal-based material including copper, nickel, aluminum, silver, and/or the like, in the form of metal powders or metal fibers; a conductive polymer such as a polyphenylene derivative; and/or a (e.g., any suitable) mixture thereof.

The negative electrode current collector may include a copper foil, a nickel foil, a stainless steel foil, a titanium foil, a nickel foam, a copper foam, a polymer substrate coated with a conductive metal, and/or a (e.g., any suitable) combination thereof.

### Electrolyte

The electrolyte for a rechargeable lithium battery may include a non-aqueous organic solvent and a lithium salt.

The non-aqueous organic solvent serves as a medium for transmitting ions that take part in the electrochemical reaction of the rechargeable lithium battery.

The non-aqueous organic solvent may be a carbonate-based, solvent, an ester-based, solvent, an ether-based, solvent, a ketone-based, solvent, an alcohol-based solvent, an aprotic solvent, or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, decanolide, γ-butyrolactone, mevalonolactone, valerolactone, caprolactone, and/or the like. The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone. The alcohol-based solvent may include ethyl alcohol, isopropyl alcohol, and/or the like, and the aprotic solvent may include nitriles such as R-CN (wherein R is a C2 to C20 linear, branched, or cyclic hydrocarbon group, and may include a double bond, an aromatic ring, or an ether group), amides such as dimethylformamide, dioxolanes such as 1,3-dioxolane or 1,4-dioxolane, sulfolanes, and/or the like.

The non-aqueous organic solvent may be used alone or in combination of two or more thereof.

If (e.g., when) a carbonate-based solvent is used, a cyclic carbonate and a chain carbonate may be mixed and used, and the cyclic carbonate and the chain carbonate may be mixed at a volume ratio of about 1:1 to about 1:9.

In one or more embodiments, the electrolyte may further include vinylethylene carbonate, vinylene carbonate, difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and/or a (e.g., any suitable) combination thereof as an additive.

The lithium salt dissolved in the non-aqueous organic solvent supplies lithium ions in the rechargeable lithium battery, enables a basic operation of the rechargeable lithium battery, and improves transportation of the lithium ions between positive and negative electrodes. Non-limiting examples of a lithium salt may include one or more selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSl), LiC₄F₉SO₃, LiN(CₓF₂ₓ₊₁SO₂)(C_{y}F_{2y+1}SO₂)(x and y are integers from 1 to 20), lithium trifluoromethane sulfonate, lithium tetrafluoroethanesulfonate, lithium difluorobis(oxalato)phosphate, (LiDFBOP), and lithium bis(oxalato) borate (LiBOB).

### Separator

The rechargeable lithium battery may further include a separator between the negative electrode and the positive electrode, depending on a type (kind) of the rechargeable lithium battery. Non-limiting examples of a suitable separator material may include polyethylene, polypropylene, polyvinylidene fluoride, and multi-layers thereof, such as a polyethylene/polypropylene double-layered separator, a polyethylene/polypropylene/polyethylene triple-layered separator, and a polypropylene/polyethylene/polypropylene triple-layered separator.

The separator may include a porous substrate and a coating layer including an organic material, an inorganic material, and/or a (e.g., any suitable) combination thereof on a surface (e.g., on one or both (e.g., simultaneously) surfaces (e.g., two opposite surfaces)) of the porous substrate.

The porous substrate may be a polymer film formed of any one selected from among polyolefins such as polyethylene and/or polypropylene, polyesters such as polyethylene terephthalate and/or polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, and polytetrafluoroethylene (e.g., TEFLON), or may be a copolymer or a mixture of two or more thereof.

The organic material may include a polyvinylidene fluoride-based polymer and/or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiOs, Mg(OH)₂, boehmite, and/or a (e.g., any suitable) combination thereof, but embodiments of the present disclosure are not limited thereto.

In one or more embodiments, the organic material and the inorganic material may be mixed in one coating layer, or a coating layer including an organic material and a coating layer including an inorganic material may be stacked.

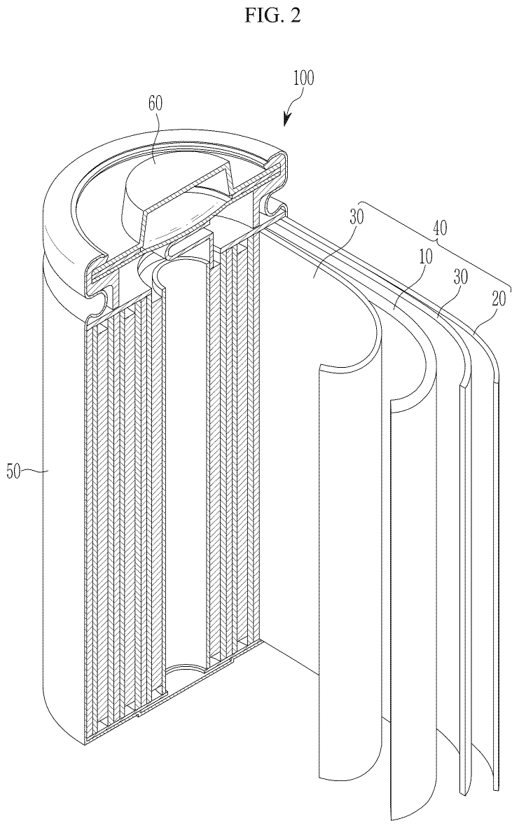

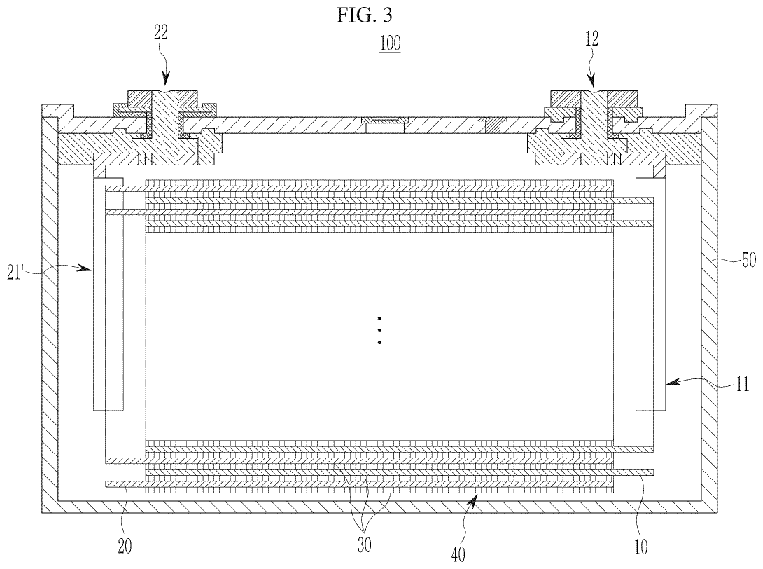

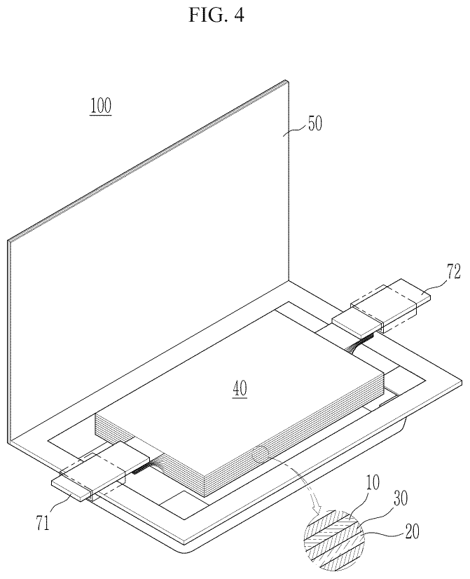

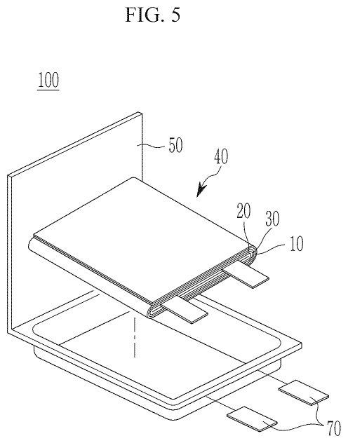

The rechargeable lithium battery may be classified into a cylindrical, prismatic, pouch, or coin-type (kind) battery, and/or the like, depending on the shape thereof. FIGS. 2 to 5 are each a schematic view illustrating a rechargeable lithium battery according to one or more embodiments of the present disclosure. FIG. 2 shows a cylindrical battery, FIG. 3 shows a prismatic battery, and FIGS. 4 and 5 each show a pouch-type (kind) battery. Referring to FIGS. 2 to 5, the rechargeable lithium battery 100 may include an electrode assembly 40 including a separator 30 between a positive electrode 20 and a negative electrode 10, and a case 50 in which the electrode assembly 40 is housed. The positive electrode 20, the negative electrode 10, and the separator 30 may be impregnated with an electrolyte solution. In one or more embodiments, the rechargeable lithium battery 100 may include a sealing member 60 sealing the case 50 as shown in FIG. 2. In one or more embodiments, as shown in FIG. 3, the rechargeable lithium battery 100 may include a positive electrode lead tab 21′, a positive terminal 22, a negative electrode lead tab 11, and a negative terminal 12. In one or more embodiments, as shown in FIG. 5, the rechargeable lithium battery 100 may include an electrode tab 70 that serves as an electrical path for conducting current formed in the electrode assembly 40 to the outside, i.e., a positive electrode tab 71 and a negative electrode tab 72 as shown in FIG. 4.

The rechargeable lithium battery according to one or more embodiments may be applied to automobiles, mobile phones, and/or one or more suitable types (kinds) of electrical devices, but embodiments of the present disclosure are not limited thereto.

Hereinafter, examples of the present disclosure and comparative examples will be described. These examples, however, are not in any sense to be interpreted as limiting the scope of present disclosure.

### Example 1

A 1a layer composition was prepared by mixing 97.86 wt % of LiNi_{0.8}Co_{0.1}Mn_{0.1}O₂, 1.54 wt % of a polyvinylidene fluoride binder, and 0.6 wt % of a Ketjen black conductive material were mixed in an N-methyl pyrrolidone solvent.

A 1b layer composition was prepared by mixing 98.74 wt % of LiNi_{0.8}Co_{0.1}Mn_{0.1}O₂, 0.66 wt % of a polyvinylidene fluoride binder, and 0.6 wt % of a Ketjen black conductive material in an N-methyl pyrrolidone solvent.

A second layer composition was prepared by mixing 98.3 wt % of LiNi_{0.8}Co_{0.1}Mn_{0.1}O₂, 1.1 wt % of a polyvinylidene fluoride binder, and 0.6 wt % of a Ketjen black conductive material in an N-methyl pyrrolidone solvent.

The 1a layer composition was coated on one surface of an Al current collector and then, dried and compressed to form a 1a layer. On this 1a layer, the 1b layer composition was coated and then, dried and compressed to form a 1b layer and thus a first positive electrode active material layer of the 1a layer and the 1b layer was formed. The compression process was performed to have a thickness ratio of 5:5 between the 1a layer and the 1b layer, wherein the 1a layer had a thickness of 70.5 μm, while the 1b layer had a thickness of 70.5 μm, and accordingly, the first positive electrode active material layer had a thickness of 141 μm and a loading level of 40.83 g/cm².

Subsequently, on the other surface of the Al current collector having the first positive electrode active material layer on one surface thereof, the second layer composition was coated and then, dried and compressed to form a second positive electrode active material layer, thus manufacturing a positive electrode having the first positive electrode active material layer and the second positive electrode active material layer. The second positive electrode active material layer had a thickness of 63.5 μm and a loading level of 16.33 g/cm².

The positive electrode, a lithium metal counter electrode, and an electrolyte were used to manufacture a coin half-cell (theoretical capacity (nominal capacity): 5.95 mAh (=1 C)).

In summary, the 1a layer composition was prepared by mixing 97.86 wt % of LiNi_{0.8}Co_{0.1}Mn_{0.1}O₂, 1.54 wt % of a polyvinylidene fluoride binder, and 0.6 wt % of Ketjen black conductive material in an N-methyl pyrrolidone solvent.

Similarly, the 1b layer composition was prepared with 98.74 wt % of LiNi_{0.8}Co_{0.1}Mn_{0.1}O₂, 0.66 wt % of the polyvinylidene fluoride binder, and 0.6 wt % of Ketjen black conductive material.

The second layer composition was also prepared with 98.3 wt % of LiNi_{0.8}Co_{0.1}Mn_{0.1}O₂, 1.1 wt % of the polyvinylidene fluoride binder, and 0.6 wt % of Ketjen black conductive material.

The 1a layer composition was coated on one surface of an Al current collector, dried, and compressed to form the 1a layer. The 1b layer composition was then coated on the 1a layer, dried, and compressed to form the 1b layer, resulting in the first positive electrode active material layer with the total thickness of 141 μm and the loading level of 40.83 g/cm². On the opposite surface of the current collector, the second layer composition was coated, dried, and compressed to form the second positive electrode active material layer with the thickness of 63.5 μm and the loading level of 16.33 g/cm². This positive electrode, along with the lithium metal counter electrode and the electrolyte, was used to manufacture the coin half-cell with a theoretical capacity of 5.95 mAh.

### Example 2

A positive electrode and a coin half-cell were manufactured in substantially the same manner as in Example 1 except that the first positive electrode active material layer was formed to include the 1a layer with a thickness of 42.4 μm and the 1b layer with a thickness of 42.4 μm and thus have a thickness of 84.8 μm and a loading level of 25.89 g/cm², and the second positive electrode active material layer was formed to have a thickness of 62.8 μm and a loading level of 16.18 g/cm².

### Example 3

A 1a layer composition was prepared by mixing 98.08 wt % of LiNi_{0.8}Co_{0.1}Mn_{0.1}O₂, 1.32 wt % of a polyvinylidene fluoride binder, and 0.6 wt % of a Ketjen black conductive material in an N-methyl pyrrolidone solvent.

A 1b layer composition was prepared by mixing 98.52 wt % of LiNi_{0.8}Co_{0.1}Mn_{0.1}O₂, 0.88 wt % of a polyvinylidene fluoride binder, and 0.6 wt % of a Ketjen black conductive material in an N-methyl pyrrolidone solvent.

A positive electrode and a coin half-cell were manufactured in substantially the same manner as in Example 1 except that instant 1a layer composition and the 1b layer composition were used.

### Example 4

A positive electrode and a coin half-cell were manufactured in substantially the same manner as in Example 2 except that the 1a layer composition and the 1b layer composition of Example 3 were used.

### Comparative Example 1

A positive electrode and a coin half-cell were manufactured in substantially the same manner as in Example 1 except that the first positive electrode active material layer was formed to include the 1a layer with a thickness of 69.1 μm and the 1b layer with a thickness of 69.1 μm and thus to have a thickness of 138.2 μm and a loading level of 35.6 g/cm², and the second positive electrode active material layer was formed to have a thickness of 138.2 μm and a loading level of 35.6 g/cm².

### Comparative Example 2

A positive electrode and a coin half-cell were manufactured in substantially the same manner as in Example 1 except that the first positive electrode active material layer was formed to include the 1a layer with a thickness of 95.4 μm and the 1b layer with a thickness of 95.4 μm and thus to have a thickness of 190.8 μm and a loading level of 52.7 g/cm², and the second positive electrode active material layer was formed to have a thickness of 60 μm and a loading level of 15.5 g/cm².

### Comparative Example 3

A 1a layer composition was prepared by mixing 98.74 wt % of LiNi_{0.8}Co_{0.1}Mn_{0.1}O₂, 0.66 wt % of a polyvinylidene fluoride binder, and 0.6 wt % of a Ketjen black conductive material in an N-methyl pyrrolidone solvent.

A 1b layer composition was prepared by mixing 97.86 wt % of LiNi_{0.8}Co_{0.1}Mn_{0.1}O₂, 1.54 wt % of a polyvinylidene fluoride binder, and 0.6 wt % of a Ketjen black conductive material in an N-methyl pyrrolidone solvent.

A positive electrode and a coin half-cell were manufactured in substantially the same manner as in Example 1 except that the instant 1a layer composition and 1b layer composition were used.

### Comparative Example 4

A positive electrode and a coin half-cell were manufactured in substantially the same manner as in Example 2 except that the 1a layer composition and the 1b layer composition of Comparative Example 3 were used.

### Comparative Example 5

A 1a layer composition was prepared by mixing 98.3 wt % of LiNi_{0.8}Co_{0.1}Mn_{0.1}O₂, 1.1 wt % of a polyvinylidene fluoride binder, and 0.6 wt % of a Ketjen black conductive material in an N-methyl pyrrolidone solvent.

A 1b layer composition was prepared by mixing 98.3 wt % of LiNi_{0.8}Co_{0.1}Mn_{0.1}O₂, 1.1 wt % of a polyvinylidene fluoride binder, and 0.6 wt % of a Ketjen black conductive material in an N-methyl pyrrolidone solvent.

A positive electrode and a coin half-cell were manufactured in substantially the same manner as in Comparative Example 3 except that the instant 1a layer composition and 1b layer composition were used.

### Experimental Example 1) Porosity Measurement

Each of the positive electrodes according to Examples 1 to 4 and Comparative Examples 1 to 5 was measured with respect to porosities of the 1a layer and the 1b layer in a mercury porosity analysis method. A ratio (Pb/Pa) of porosity (Pb) of the 1b layer to porosity (Pa) of the 1a layer was calculated, and the results are shown in Table 1.

In each of the positive electrodes of Examples 1 to 4 and the Comparative Examples 1 to 5, a ratio (D1:D2) of the thickness (D1) of the first positive electrode active material layer and the thickness (D2) of the second positive electrode active material layer was calculated, and the results are shown in Table 1. In the manufacture of each of the positive electrodes of Example 1 to 4 and Comparative Examples 1 to 5, a ratio (Wb:Wa) of a binder amount (Wb) of the 1b layer composition and a binder amount (Wa) of the 1a layer composition was calculated, and the results are shown in Table 1.

TABLE 1

| | | | Binder | | | | Porosity of |
|---|---|---|---|---|---|---|---|
| | | | ratio | | | | second positive |
| | Thickness | Loading | (Wb:Wa, | | | Porosity | electrode |
| | ratio | level ratio | weight | Porosity | Porosity | ratio | active material |
| | (D1:D2) | (D1:D2) | ratio) | (Pa, %) | (Pb, %) | (Pb/Pa) | layer (%) |
| Example 1 | 2.22:1 | 2.5:1 | 3:7 | 15.7 | 16.5 | 1.05 | 14.2 |
| Example 2 | 1.35:1 | 1.6:1 | 3:7 | 15.9 | 16.9 | 1.06 | 14.0 |
| Example 3 | 2.22:1 | 2.5:1 | 4:6 | 16.8 | 15.5 | 0.92 | 14.5 |
| Example 4 | 1.35:1 | 1.6:1 | 4:6 | 17.0 | 15.8 | 0.93 | 13.8 |
| Comparative | 1:1 | 1:1 | 3:7 | 15.4 | 16.5 | 1.07 | 14.1 |
| Example 1 | | | | | | | |
| Comparative | 3.18:1 | 3.4:1 | 3:7 | 15.1 | 16.3 | 1.08 | 14.4 |
| Example 2 | | | | | | | |
| Comparative | 2.22:1 | 2.5:1 | 7:3 | 30.5 | 5.49 | 0.18 | 15.0 |
| Example 3 | | | | | | | |
| Comparative | 1.35:1 | 1.6:1 | 7:3 | 29.9 | 4.49 | 0.15 | 14.7 |
| Example 4 | | | | | | | |
| Comparative | 2.22:1 | 2.5:1 | 5:5 | 20.1 | 8.64 | 0.43 | 14.0 |
| Example 5 | | | | | | | |

As shown in Table 1, the positive electrodes of Examples 1 to 4 and the positive electrodes of Comparative Examples 1 and 2 each exhibited a similar porosity ratio of the 1b layer to the 1a layer in a range of 0.92 to 1.07. In contrast, Comparative Examples 3 to 5 exhibited a porosity ratio of 0.15 or 0.43, which confirmed that the 1b layer and the 1a layer had a large porosity difference.

### Experimental Example 2) Charge Rate Evaluation

The half-cells according to Examples 1 to 4 and Comparative Examples 1 to 5 were each twice charged and discharged at 0.2 C and 25° C. for formation. After the formation charge and discharge, while changing a charge C-rate, the cells were each charged and discharged by one cycle at each rate, as follows.

Charge: constant current/constant voltage (CC/CV), 0.2 C, 0.33 C, 0.5 C, 0.75 C, 1.0 C, 1.5 C, 2.0 C/4.3 V/0.05 C cut-off

Discharge: constant current (CC) 0.2 C/3.0 V cut-off

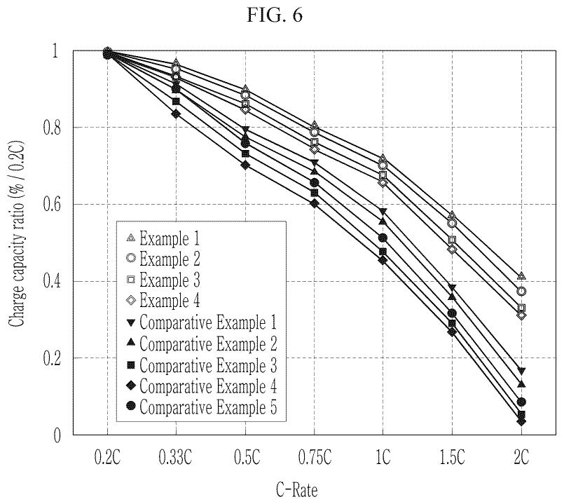

At each rate, the cells were each charged to a CC-CV upper limit voltage of 4.3 V and cut off at 0.05 C. Based on 100% of charge capacity during the 0.2 C CC-CV charge, a constant current (CC) charge capacity ratio at each C-rate was obtained, and the results are shown in FIG. 6.

As shown in FIG. 6, the cells of Examples 1 to 4 each exhibited a much more excellent or suitable charge rate capability than those of Comparative Examples 1 to 5. In particular, very excellent or suitable charge rate capability at a high rate was obtained.

### Experimental Example 3) Cycle-life Characteristics Evaluation

The cells according to Examples 1 and 2 and Comparative Examples 1 and 2 were each charged and discharged under the following conditions at 25° C.

0.2 C: Constant current-constant voltage (CC-CV) 0.2 C charge 4.3 V/0.05 C cut-off, 20 minutes pause, constant current (CC) 0.2 C discharge 3.0 V cut-off, 20 minutes pause, repetition 10 times

0.5 C: Constant current-constant voltage (CC-CV) 0.5 C charge 4.3 V/0.05 C cut-off, 20 minutes pause, constant current (CC) 0.2 C discharge 3.0 V cut-off, 20 minutes pause, repetition 10 times

1 C: Constant current-constant voltage (CC-CV) 1 C charge 4.3 V/0.05 C cut-off, 20 minutes pause, constant current (CC) 0.2 C discharge 3.0 V cut-off, 20 minutes pause, repetition 10 times

2 C: Constant current-constant voltage (CC-CV) 2 C charge 4.3 V/0.05 C cut-off, 20 minutes pause, constant current (CC) 0.2 C discharge 3.0 V cut-off, 20 minutes pause, repetition 10 times

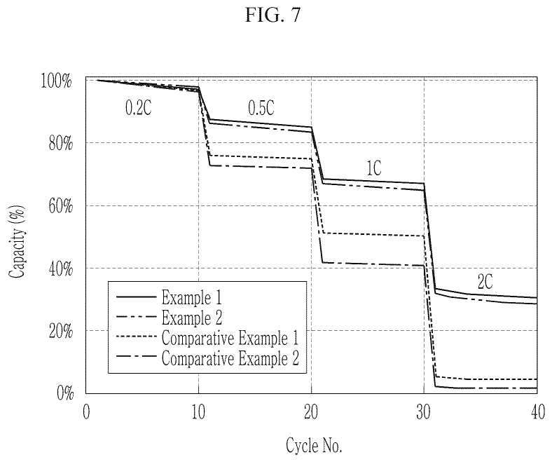

A ratio of each cycle charge capacity to the 1^{st} cycle charge capacity at 0.2 C was calculated, and the results are shown in FIG. 7.

As shown in FIG. 7, the cells of Examples 1 and 2 each exhibited more excellent or suitable cycle-life characteristics than the cells of Comparative Examples 1 and 2. In particular, the higher C-rate, the more excellent or suitable cycle-life characteristics for the cells of Examples 1 and 2, especially at 1 C and 2 C. In other words, the cells of Examples 1 and 2 exhibited excellent cycle-life characteristics at a high C-rate compared to the cells of Comparative Examples.

As used herein, the term “Group” as utilized herein refers to a group of the Periodic Table of Elements according to the 1 to 18 grouping system of the International Union of Pure and Applied Chemistry (“IUPAC”).

In the present disclosure, it will be understood that the term “comprise(s)/comprising,” “include(s)/including,” or “have/has/having” specifies the presence of stated features, integers, steps, operations, elements, and/or components, but do not preclude the presence or addition of one or more other features, integers, steps, operations, elements, components, and/or groups thereof. Additionally, the terms “comprise(s)/comprising,” “include(s)/including,” “have/has/having”, or other similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, ±20%, ±10%, or ±5% of the stated value.

In the context of the present disclosure and unless otherwise defined, the terms “use,” “using,” and “used” may be considered synonymous with the terms “utilize,” “utilizing,” and “utilized,” respectively.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A battery (e.g., a positive electrode) manufacturing device, a battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

While the present disclosure has been described in connection with what is presently considered to be example embodiments, it is to be understood that the present disclosure is not limited to the disclosed embodiments, but, on the contrary, is intended to cover one or more suitable modifications and equivalent arrangements included within the spirit and scope of the appended claims and equivalents thereof.

What is claimed is:

1. A positive electrode, comprising
a current collector;
a first positive electrode active material layer on a first surface of the current collector; and
a second positive electrode active material layer on a second surface of the current collector,
wherein the first positive electrode active material layer comprises a first layer in contact with the current collector and a second layer on a surface of the first layer,
the first layer and the second layer each comprise a positive electrode active material and a binder,
the first layer and the second layer each have pores, and a ratio of a porosity of the second layer to a porosity of the first layer is about 0.8 to about 1.3, and
a thickness ratio of the first positive electrode active material layer to the second positive electrode active material layer is about 1.3:1 to about 3:1, and
wherein the positive electrode is a positive electrode for a rechargeable lithium battery.

2. The positive electrode as claimed in claim 1, wherein the second positive electrode active material layer is a single layer.

3. The positive electrode as claimed in claim 1, wherein a ratio of a thickness of the first layer to a thickness of the second layer is about 5:5 to about 3:7.

4. The positive electrode as claimed in claim 1, wherein a ratio of a porosity of the second layer to a porosity of the first layer is about 0.9 to about 1.2.

5. The positive electrode as claimed in claim 1, wherein a porosity of the first layer is about 10% to about 30%.

6. The positive electrode as claimed in claim 1, wherein a porosity of the second layer is about 10% to about 30%.

7. The positive electrode as claimed in claim 1, wherein a porosity of the second positive electrode active material layer is about 5% to about 20%.

8. The positive electrode as claimed in claim 1, wherein a ratio of a binder amount of the second layer to a binder amount of the first layer is about 4:6 to about 6:4 in weight ratio.

9. The positive electrode as claimed in claim 1, wherein a binder amount of the first layer is about 0.5 wt % to about 4 wt % based on 100 wt % of a total weight of the first positive electrode active material layer.

10. The positive electrode as claimed in claim 1, wherein a binder amount of the second layer is about 0.5 wt % to about 3.5 wt % based on 100 wt % of a total weight of the first positive electrode active material layer.

11. The positive electrode as claimed in claim 1, wherein a thickness ratio of the first layer to the second layer is about 4:6 to about 3:7.

12. The positive electrode as claimed in claim 1, wherein a binder amount of the first positive electrode active material layer is about 1 wt % to about 4 wt % based on 100 wt % of a total weight of the first positive electrode active material layer.

13. The positive electrode as claimed in claim 1, wherein a binder amount of the second positive electrode active material layer is about 1 wt % to about 4 wt % based on 100 wt % of a total weight of the second positive electrode active material layer.

14. A method, comprising
coating a first layer composition comprising a positive electrode active material, a binder, a conductive agent, and a solvent on a first surface of a current collector to manufacture a first layer;
coating a second layer composition comprising a positive electrode active material, a binder, a conductive material, and a solvent on the first layer to manufacture a first positive electrode active material layer comprising the first layer and a second layer; and
coating a second positive electrode active material layer composition comprising a positive electrode active material, a binder, a conductive material, and a solvent on a second surface of the current collector to manufacture a second positive electrode active material layer, the second surface of the current collector being opposite the first surface of the current collector,
wherein a binder amount comprised in the first layer composition is greater than a binder amount comprised in the second layer composition, and
a thickness ratio of the first positive electrode active material layer to the second positive electrode active material layer is about 1.3:1 to about 3:1, and
wherein the method is a method of manufacturing a positive electrode for a rechargeable lithium battery.

15. The method as claimed in claim 14, wherein the binder amount comprised in the first layer composition is about 60 wt % to about 90 wt % based on 100 wt % of a total binder amount of the first layer composition and the second layer composition.

16. The method as claimed in claim 14, wherein the binder amount comprised in the second layer composition is about 10 wt % to about 40 wt % based on 100 wt % of a total binder amount of the first layer composition and the second layer composition.

17. The method as claimed in claim 14, wherein a ratio of the binder amount comprised in the second layer composition to the binder amount comprised in the first layer composition is a weight ratio of about 1:9 to about 4:6.

18. A rechargeable lithium battery, comprising
the positive electrode as claimed in claim 1;
a negative electrode; and
a non-aqueous electrolyte.
